(19) United States
(12) Patent Application Publication
(10) Pub. No.: US 2019/0331843 A1
(43) Pub. Date: Oct. 31, 2019

(54) COMPOSITE LIGHT GUIDING MEMBER, LIGHTING DEVICE, AND DISPLAY DEVICE

(71) Applicant: SHARP KABUSHIKI KAISHA, Osaka (JP)

(72) Inventors: HIDETO YASUMOTO, Sakai City (JP); OSAMU ITOH, Sakai City (JP)

(21) Appl. No.: 16/393,658

(22) Filed: Apr. 24, 2019

(30) Foreign Application Priority Data
Apr. 27, 2018 (JP) 2018-086407

(51) Int. Cl. F21V 8/00

(52) U.S. Cl. CPC G02B 6/009; G02B 6/0088; G02B 6/0083; G02B 6/0068

(57) ABSTRACT

A composite light guiding member includes light sources, a light guide plate, and a light source substrate that is flexible. The light source substrate includes a switching circuit, amounting surface, and a flexible curved section. The switching circuit is configured to control turn-on and turn-off of the light sources. The light source substrate includes a first side edge and a second side edge fixed to a first plate surface and a second plate surface of the light guide plate, respectively. The light sources are arranged along the first side edge and mounted on the mounting surface between the first side edge and the second side edge. The flexible curved section includes the mounting surface. The flexible curved section is folded so that the light sources are opposed to a light entering surface of the light guide plate and displaceable relative to the light entering surface.

### CROSS REFERENCE TO RELATED APPLICATION

This application claims priority from Japanese Patent Application No.2018-086407 filed on Apr. 27, 2018. The entire contents of the priority application are incorporated herein by reference.

### TECHNICAL FIELD

The technology described herein relates to a composite light guiding member, a lighting device, and a display device.

### BACKGROUND

In a display device including a liquid crystal panel or the like which does not produce self-luminescence as a display panel which displays an image, a backlight device (an example of a lighting device) for irradiating the display panel with light is attached to a rear surface on the opposite side to an image display surface of the display panel. Although the backlight device includes a light source, a light source substrate on which the light source is mounted, a light guide plate which converts a light flux from the light source into screen luminescence, and a chassis (an example of a holder) made of a metal, for example, which accommodates the light source, the light source substrate, and the light guide plate, a predetermined clearance may be provided between the light guide plate and the chassis. This is to prevent the light source and the light guide plate from physically interfering with each other when a temperature within the backlight device rises due to heat generation from the light source or the like and the light guide plate thermally expands with the rise of the temperature. However, when the clearance is provided, as described above, a relative positional relationship between the light source and the light guide plate may change when the light guide plate thermally expands or thermally contracts. When the relative positional relationship between the light source and the light guide plate changes, an incidence efficiency with which light emitted from the light source is incident on a light entering surface of the light guide plate and thus an emission efficiency of light emitted from a light emission surface of the light guide plate change so that the brightness levels of the lighting device and thus the display device become unstable. A technology described in Japanese Patent Application Laid-Open No. 2006-164521 has been known as a solution to such a problem.

Japanese Patent Application Laid-Open No. 2006-164521 discloses a backlight device having a configuration in which a flexible light source substrate is locked into a recess or the like formed in a frame body and is held in an elastically deformed state. In the backlight device, its brightness level is stabilized by urging the light source in a direction toward the light guide plate using a restoring force of the light source substrate elastically deformed, to fix the light guide plate in the frame body while keeping a distance between the light guide plate and the light source constant.

However, in the above-described configuration, a structure such as the recess for locking the light source substrate needs to be formed in the frame body. Accordingly, a frame body structure is liable to be complicated, and a frame body having a conventional configuration is difficult to use as it is. When the light guide plate and the light source substrate are assembled to the frame body, the light source substrate needs to be aligned, fitted, and locked into the recess or the like in the frame body. Accordingly, a high assembly accuracy is required, and work becomes complicated.

### SUMMARY

The technology described herein was made in view of the above circumstances. An object is to stabilize the respective brightness levels of the lighting device and the display device using a simple configuration.

A composite light guiding member described herein includes light sources, a light guide plate, and a light source substrate. The light guide plate has a plate shape. The light guide plate includes a first plate surface, a second plate surface, and an end surface. The end surface includes a light entering surface through which light emitted by the light sources enters. At least one of the first plate surface and the second plate surface includes a light exiting surface through which planar light exits. The light source substrate has a sheet shape. The light source substrate is flexible. The light source substrate includes a switching circuit, a first side edge, a second side edge, a mounting surface, and a flexible curved section. The switching circuit is configured to control turn-on and turn-off of the light sources. The first side edge is fixed to the first plate surface. The second side edge is fixed to the second plate surface. The light sources are disposed on the mounting surface along the first edge. The mounting surface is between the first side edge and the second side edge. The flexible curved section includes the mounting surface. The flexible curved section is folded so that the light sources are opposed to the light entering surface and displaceable relative to the light entering surface.

According to the above-described configuration, the first and the second side edges of the light source substrate are fixed to the light guide plate so that a positional relationship between the light entering surface of the light guide plate and the light source is maintained substantially constant. Accordingly, an influence of a dimensional change of the light guide plate on a brightness level is suppressed. The light source is preferably disposed in close proximity to the light entering surface from the viewpoint of maintaining the positional relationship between the light entering surface of the light guide plate and the light source to be constant.

Usually, a large number of wirings constituting the switching circuit are disposed on the light source substrate. Accordingly, a content area is required. According to the above-described configuration, the light source substrate is folded such that its cross section forms a U shape, for example, so that a wiring region forms the flexible curved section. As a result, in a lighting device including the flexible curved section, the dimensional change of the light guide plate can be absorbed.

An effect of maintaining the relative positional relationship and an effect of absorbing the dimensional change of the light guide plate by the flexible curved section, as described above, can be obtained without providing a special structure in a holder in the lighting device nor performing special assembling work but by only disposing the composite light guiding member having the above-described configuration previously manufactured within a holder having a similar configuration to that in a conventional example.

Furthermore, according to the above-described configuration, the light entering surface of the light guide plate is covered with the light source substrate. Accordingly, a situation, where a foreign substance drops to be mixed between the light source, the light source substrate, thus a reflective sheet disposed thereunder, and the like and the light guide plate, causing a display defect and damaging each of members, can be reduced.

Note that in the above-described configuration, “curved” includes not only a structure folded along a specific folding line such that its cross section has a vertex portion but also a structure curved such that its cross section draws a smooth curve, for example. The flexible curved section preferably is a structure curved such that its cross section draws a smooth curve from the viewpoint of reducing stress concentration at the time of elastic deformation and suppressing damage to a wiring pattern of the switching circuit, for example.

According to the technology described herein, a lighting device and a display device the respective brightness levels of which have been stabilized using a simple configuration.

### BRIEF DESCRIPTION OF THE DRAWINGS

FIG. 1 is an exploded schematic view illustrating a schematic configuration of a liquid crystal display device according to a first embodiment.

FIG. 2 is a schematic view illustrating an outline of a cross-sectional configuration of the liquid crystal display device.

FIG. 3 is a schematic view illustrating an outline of a cross-sectional configuration of a lighting device according to a first modification to the first embodiment.

FIG. 4 is a schematic view illustrating an outline of a cross-sectional configuration of a lighting device according to a second modification to the first embodiment.

### DETAILED DESCRIPTION

### First Embodiment

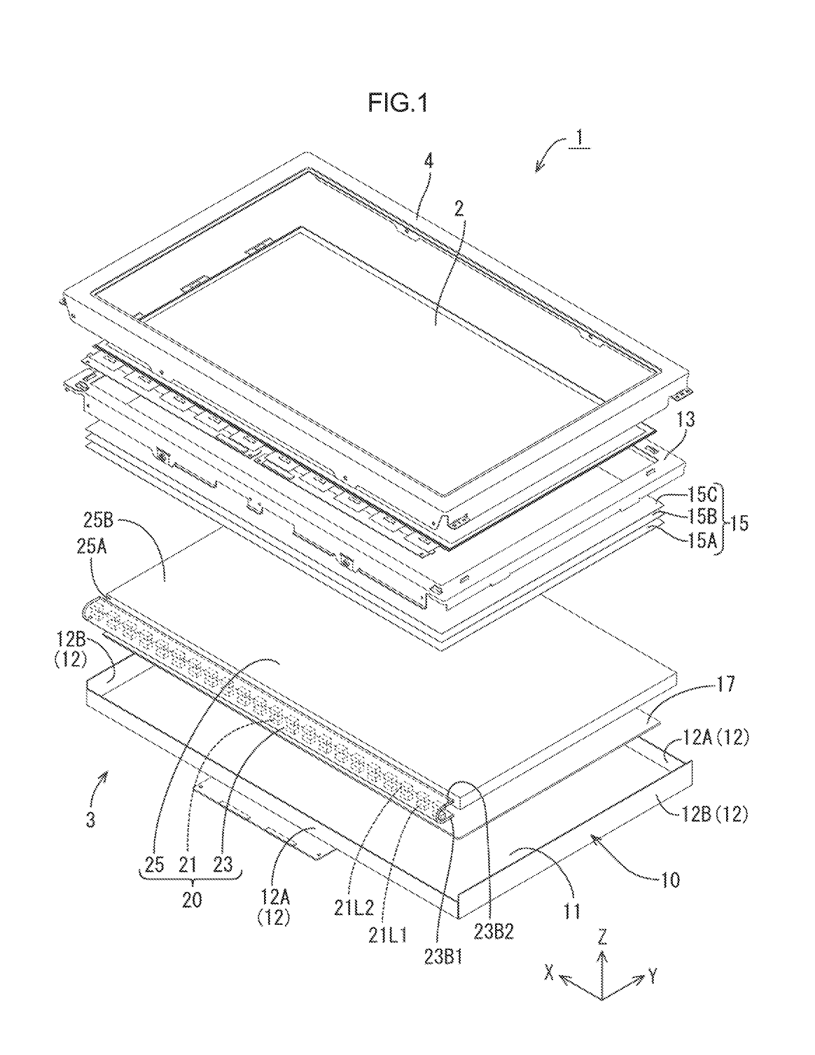

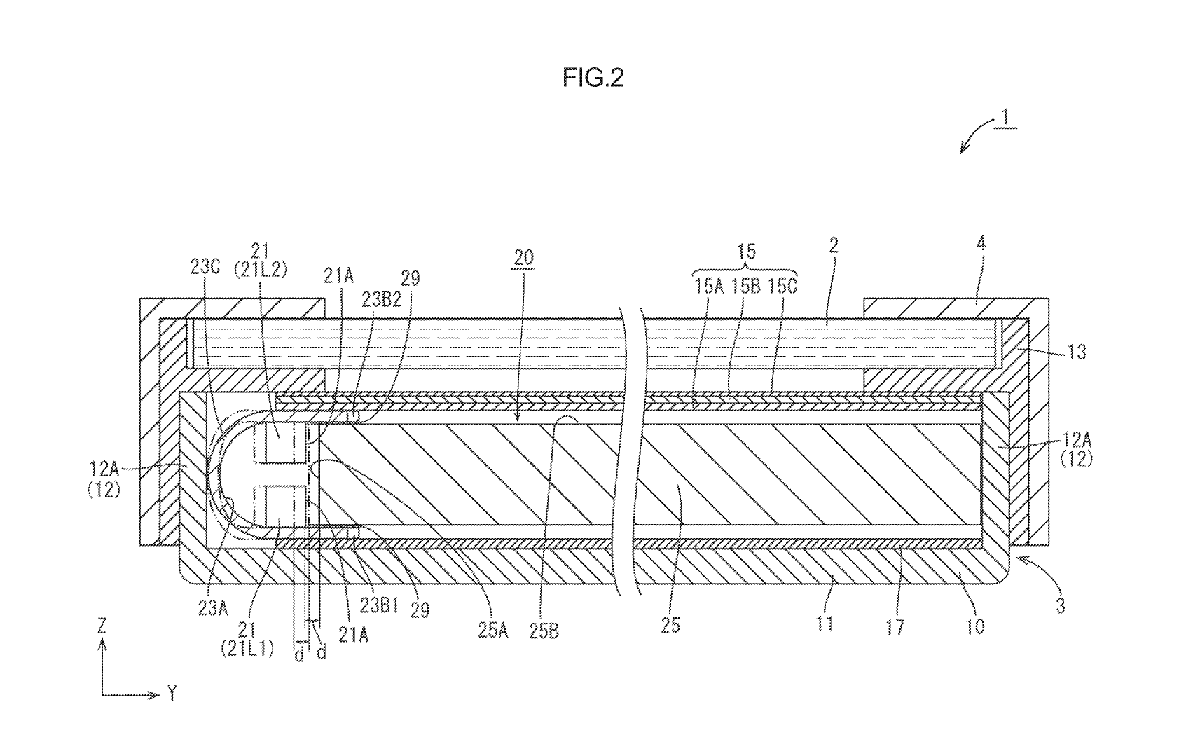

A first embodiment will be described with reference to FIGS. 1 and 2.

In the present embodiment, a liquid crystal display device (an example of a display device) 1 will be illustrated as an example. Note that an X-axis, a Y-axis, and a Z-axis are illustrated in a part of the drawing. An upper side in FIG. 2 is set as a front side (a lower side is set as a back side). For one or more identical members, one of the members may be assigned a reference numeral, to omit respective reference numerals of the other members.

The liquid crystal display device 1 according to the present embodiment is used for a television receiver, for example, and includes a liquid crystal panel (an example of a display panel) 2 having a relatively large size of approximately 30 inches to 70 inches, for example. The liquid crystal display device 1 forms a horizontally long square shape (a rectangular shape) as a whole, and is used in a longitudinally placed state. The liquid crystal display device 1 has roughly a configuration in which a backlight device (an example of a lighting device) 3 as an external light source is disposed on the back side of the liquid crystal panel 2 having its plate surface on the front side as an image display surface and is integrally held therein by a bezel 4 having a rectangular frame shape. Note that, although the technology is particularly preferably applicable to a display device of a relatively large size including a large number of light sources and having a complicated wiring formed on its light source substrate, the present invention is not limited to this. The present invention is also applicable to a display device including a display panel, the screen size of which is from a small size of 30 inches or less to a middle size, used for a tablet terminal, a car navigation device, a smartphone, or a head mounted display, for example.

Although details of the liquid crystal panel 2 are not illustrated, the liquid crystal panel 2 forms an outline of a rectangular plate shape and is formed by bonding paired glass substrates with a predetermined gap defined therebetween while sealing a liquid crystal between both the glass substrates, for example. A switching element (e.g., a TFT (thin film transistor)) connected to a source line and a gate line which are perpendicular to each other, a pixel electrode connected to the switching element, and further an alignment film, for example, are provided on one of the glass substrates, and a color filter in which respective colored portions in R (red), G (green), B (blue), and the like are arranged in a predetermined array, a counter electrode, and further an alignment film, for example, are provided on the other glass substrate. A polarizing plate is disposed outside both the glass substrates. Note that the liquid crystal panel 2 is disposed such that a normal direction of its plate surface matches a Z-axis direction.

Driving of the liquid crystal panel 2 is controlled by a liquid crystal panel control section (not illustrated). The liquid crystal panel control section outputs a control signal toward the liquid crystal panel 2 based on an output signal outputted from an image signal processing section (not illustrated) while controlling the driving of the liquid crystal panel 2. Light is supplied from the backlight device 3 in cooperation with the control by the liquid crystal panel control section so that a desired image is displayed on an image display surface of the liquid crystal panel 2.

A schematic configuration of the backlight device 3 will be described with reference to FIGS. 1 and 2.

As illustrated in FIG. 1, the backlight device 3 forms an outline of a rectangular plate shape, and is disposed such that its long side direction and its short side direction respectively match an X-axis direction (horizontal direction) and a Y-axis direction (vertical direction). The backlight device 3 forms a substantially shallow box shape having an opening on its front side (the side of the liquid crystal panel 2), and includes a chassis (an example of a holder) 10 which accommodates each of members, described below, inside thereof, and a frame 13 which is attached to an edge of the opening of the chassis 10 and inhibits each of the members accommodated inside the chassis 10 from protruding. A composite light guiding member 20 is accommodated inside the chassis 10, and an optical member 15 is disposed to cover the opening of the chassis 10 on the front side (the side of the liquid crystal panel 2) of the composite light guiding member 20 while a reflective sheet 17 is disposed on the back side of the composite light guiding member 20. The composite light guiding member 20 includes an LED (light emitting diode: an example of the light source) 21, an LED substrate (an example of the light source substrate) 23 on which the LED 21 is mounted, and a light guide plate 25 having a rectangular plate shape which guides light from the LED 21 to the optical member 15 (the liquid crystal panel 2). In the backlight device 3, the LED 21 as the light source is disposed to oppose an outer peripheral end surface of one of the long sides (the left front side in FIG. 1 and the left side in FIG. 2) of the light guide plate 25 disposed on the back side of the liquid crystal panel 2, and the outer peripheral end surface is set as a light entering surface 25A on which light from the LED 21 is incident. On the other hand, a plate surface on the front side of the light guide plate 25 is set as a light emission surface 25B from which light is emitted toward the liquid crystal panel 2. That is, the backlight device 3 according to the first embodiment is of a so-called edge light type (a side light type).

Components constituting the backlight device 3 will be sequentially described below.

The chassis 10 is a member for accommodating and supporting the composite light guiding member 20 and the like inside thereof, and is made of a metal such as an aluminum-based material. The chassis 10 includes a bottom plate 11 having a rectangular plate shape following the liquid crystal panel 2 and a side frame (an example of a frame portion) 12 formed to rise toward the front side from an outer peripheral end of the bottom plate 11 to form a rectangular frame shape. In the side frame 12, a pair of side frames, each of which rises from an outer end of a long side of the bottom plate 11, is set as long side plates 12A, and a pair of side frames, each of which rises from an outer end of a short side of the bottom plate 11, is set as short side plates 12B. The bottom plate 11 supports the composite light guiding member 20 and the like from the back side, i.e., the side of a surface opposite to the light emission surface 25B, and the side frame 12 is disposed to surround an outer periphery of the composite light guiding member 20 or the like to support the composite light guiding member 20 from the side of the outer periphery. Dimensions of the chassis 10, for example, will be described below again. Note that a power supply circuit board which supplies power to the liquid crystal panel 2 and the LED 21 described below, for example, an LED control circuit board which controls driving of the LED 21, a liquid crystal control circuit board including the liquid crystal panel control section already described, and the like are attached to the back side of the bottom plate 11 in the chassis 10, i.e., the back side of the backlight device 3.

The frame 13 is made of synthetic resin such as polycarbonate, and is formed to form a similar rectangular frame shape to that of a bezel 4. A white frame and a black frame are preferably used, respectively, from the viewpoint of increasing a light utilization efficiency and preventing light leakage to the outside of the backlight device 3. The frame 13 is fixed to the side frame 12 along an edge of the opening of the chassis 10, and holds an outer edge of the optical member 15, described below, with the outer edge sandwiched between the composite light guiding member 20 and itself while supporting an outer peripheral edge of the liquid crystal panel 2 from its back side, as illustrated in FIG. 2.

The optical member 15 includes one or more sheets each having an outline of a rectangular shape following the liquid crystal panel 2 and the bottom plate 11 in the chassis 10. As the optical member 15, the sheets disposed to be interposed between the liquid crystal panel 2 and the composite light guiding member 20 and respectively producing various optical effects depending on functions to be required can be used in combination, as needed. In the first embodiment, a diffusion sheet 15A, a lens sheet 15B, and a reflective polarizing sheet 15C are stacked in this order from the side of the composite light guiding member 20 when used as an example. The optical member 15 has a function of improving the brightness level of light emitted toward the liquid crystal panel 2 from the light guide plate 25 in the composite light guiding member 20 or changing the light into uniformly planar light.

As the reflective sheet 17, a reflective sheet made of synthetic resin such as foamed polyethylene terephthalate and having its surface set to a white surface or a mirror surface superior in light reflectivity can be used. The reflective sheet 17 is disposed in a shape covering a back surface of the light guide plate 25, i.e., a surface on the opposite side to the light emission surface 25B. In other words, the reflective sheet 17 is interposed between the bottom plate 11 in the chassis 10 and the composite light guiding member 20, and is laid to cover at least an entire region, on which the light guide plate 25 is superimposed, in the bottom plate 11. The reflective sheet 17 has a function of reflecting light emitted to the back side of the light guide plate 25 toward the front side to raise the light and emitting the light from the light emission surface 25B.

In the backlight device 3 according to the first embodiment, the LED substrate 23 on which the LED 21 is mounted is fixed to the light guide plate 25, and the LED 21, the LED substrate 23, and the light guide plate 25 are integrated, to form the composite light guiding member 20. As illustrated in FIG. 2, the composite light guiding member 20 is supported between the optical member 15 and the reflective sheet 17, already described, inside the chassis 10.

The light guide plate 25 constituting the composite light guiding member 20 is composed of a synthetic resin material (e.g., acrylic) having a refractive index sufficiently higher than that of air and being substantially transparent (superior in translucency) and forms an outline of a rectangular plate shape while being formed in a plate shape having a predetermined thickness. The light guide plate 25 is disposed in such a posture that its plate surfaces are parallel to an image display surface of the liquid crystal panel 2 on the back side of the optical member 15 inside the chassis 10, as illustrated in FIG. 2. Out of the two plate surfaces of the light guide plate 25, the plate surface disposed on the front side (on the side of the optical member 15 and the liquid crystal panel 2) is set as the light emission surface 25B from which light is emitted. Among four outer peripheral end surfaces formed to be perpendicular to the two plate surfaces of the light guide plate 25, the one outer peripheral end surface on one of the long sides (on the left front side in FIG. 1 and the left side in FIG. 2) is set as the light entering surface 25A on which light is incident because a light emission surface 21A of the LED 21, described below, is oppositely arranged. In the first embodiment, the light entering surface 25A is formed as a flat surface using the Y-axis direction as a normal direction, as illustrated in FIGS. 1 and 2. Note that the light entering surface 25A need not be formed to be flat, but may be an uneven surface formed by its portions opposing the LED 21 protruding or retreating, for example. The light guide plate 25 has a function of introducing light emitted in the Y-axis direction from the light emission surface 21A of the LED 21 from the light entering surface 25A while raising the light toward the optical member (in the Z-axis direction) while propagating the light inside thereof to emit the light from the light emission surface 25B.

The LED 21 constituting the composite light guiding member 20 has a configuration in which an LED chip is sealed with a resin material on a substrate portion bonded to the mounting surface 23A of the LED substrate 23, described below. As illustrated in FIG. 2, each of LEDs 21 used in the first embodiment is set as a so-called side surface light emitting LED in which one of side surfaces adjacent to a mounting surface on the LED substrate 23 is the light emission surface 21A and is disposed such that its optical axis substantially matches the Y-axis direction. Although as the LEDs 21, LEDs of different sizes may be together used or an LED which emits light in white and an LED which emits light in RGB colors may be used in combination, a case where only one or more white LEDs of the same size and in the same shape are used is illustrated as an example in the first embodiment.

As the LED substrate 23 constituting the composite light guiding member 20, a sheet-shaped flexible substrate which is elastically deformable is used. As the flexible substrate, a flexible substrate having a configuration in which a wiring pattern (not illustrated) composed of a metal file such as a copper foil is formed on a surface of a base material made of synthetic resin having an insulating property and having flexibility, for example, can be used. In the first embodiment, an elongated sheet-shaped LED substrate 23 having a length dimension substantially similar to that of a long side of the light entering surface 25A of the light guide plate 25 is used. One of plate surfaces of the LED substrate 23 is set as a mounting surface 23A (see FIG. 2), and is connected to a wiring pattern of a switching circuit after the LEDs 21 are mounted thereon. In the LED substrate 23 according to the first embodiment, the mounting surface 23A is set as a white surface or a mirror surface superior in light reflectivity. The LED substrate 23 may be formed using resin in a color such as white or silver having a high light reflectivity for its base material itself or may be formed by applying a coating film having a high light reflectivity onto a surface on which the wiring pattern has been formed. Note that, although the LED substrate 23 is schematically represented in FIG. 1, the LED substrate 23 can have a configuration in which a connection section to be connected to an input circuit of an external signal is formed to extend from an LED mounting portion on which the LED 21 is mounted after being formed in an elongated rectangular shape, for example.

As illustrated in FIG. 1, for example, in the LED substrate 23, one or more LEDs 21 are mounted side by side along each of a first side edge 23B1 as one side edge on the long side in the mounting surface 23A and a second side edge 23B2 as the other side edge on the long side opposite thereto, to form a first light source array 21L1 and a second light source array 21L2 in respective one columns. In the first embodiment, the LEDs 21 respectively constituting the light source arrays 21L1 and 21L2 are disposed to oppose each other at the same position in the X-axis direction, as represented in FIG. 1. As represented in FIG. 2, the LEDs 21 respectively constituting the light source arrays 21L1 and 21L2 are mounted such that their respective side surfaces on the side of the side edges 23B1 and 23B2 of the LED substrate 23 become the light emitting surfaces 21A. A region between respective mounting portions of the light source arrays 21L1 and 21L2 is set as a wiring region where a large number of wiring patterns connected to each of the LEDs 21 are formed, and the width of the wiring region, i.e., a distance between the light source arrays 21L1 and 21L2 is set to be larger than the plate thickness of the light guide plate 25.

In the LED substrate 23 on which the LEDs 21 are mounted as described above, the first side edge 23B1 is fixed to a side edge, on the side of the light entering surface 25A, on a surface on the opposite side to the light emission surface 25B of the light guide plate 25, described below, and the second side edge 23B2 is fixed to a side edge, on the side of the light entering surface 25A, on the light emission surface 25B of the light guide plate 25. The LED substrate 23 and the light guide plate 25 can be fixed to each other by a double-sided adhesive tape 29, for example. Thus, when the side edges 23B1 and 23B2 of the LED substrate 23 are respectively fixed along the light entering surface 25A to both the plate surfaces of the light guide plate 25, the light guide plate 25 and the LED substrate 23 on which the LEDs 21 are mounted are integrated, to form the composite light guiding member 20. As illustrated in FIG. 2, for example, the LED substrate 23 is held with the mounting surface 23A in both the side edges 23B1 and 23B2 being parallel to the respective plate surfaces of the light guide plate 25 and the liquid crystal panel 2 and the light emission surfaces 21A of the LEDs 21 respectively constituting the light source arrays 21L1 and 21L2 opposing the light entering surface 25A of the light guide plate 25. The LED substrate 23 is fixed to the light guide plate 25 such that the light emission surfaces 21A of the LEDs 21 mounted thereon are oppositely arranged with a very small distance d for not physically interfering with the light entering surface 25A maintained therebetween. On the other hand, in the LED substrate 23, a wiring region formed between the mounting portions of the light source arrays 21L1 and 21L2 is curved to form an elastic curved section (an example of the flexible curved section) 23C. Note that, although the elastic curved section 23C is smoothly curved without being provided with a specific folding line or the like and a cross section in its short side direction is formed to form a U shape which opens toward the light entering surface 25A of the light guide plate 25 in the first embodiment, the present invention is not limited to this. For example, the elastic curved section 23C may be folded along one folding line to form a V shape in cross section, for example, or may be folded along two folding lines to form a ⊐ shape (an angular U shape) in cross section. When the LED substrate 23 is thus fixed to the light guide plate 25, a substantially entire area of the light entering surface 25A of the light guide plate 25 is covered with the mounting surface 23A of the LED substrate 23 in the composite light guiding member 20.

The composite light guiding member 20 is accommodated in such a posture that its long side to which the LED substrate 23 is fixed is along a long side plate 12A on the left side in FIG. 2 inside the chassis 10. That is, the LED substrate 23 is held such that the elastic curved section 23C formed by the wiring region is parallel to the one long side plate 12A and the two long side plates 12A and 12A in the side frame 12 in the chassis 10 respectively function as first direction supporting sections which support the composite light guiding member 20 with the composite light guiding member 20 sandwiched from both sides in the Y-axis direction (an example of a first direction) including the elastic curved section 23C.

The chassis 10 is formed such that a distance between the two long side plates 12A becomes equal to an outer dimension in the Y-axis direction (i.e., the first direction) of the composite light guiding member 20 in a natural state. “Equal” includes not only “completely equal” but also “substantially equal”. That is, the chassis 10 may be formed such that a distance between the first direction supporting sections is larger or smaller than the outer dimension in the Y-axis direction (first direction) of the composite light guiding member 20 if it is within a range in which an effect of the present invention is obtained. In the first embodiment, the chassis 10 is formed such that the distance between the long side plates 12A is slightly smaller than the outer dimension in the Y-axis direction of the composite light guiding member 20.

Then, an action by the composite light guiding member 20 configured as described above when the light guide plate 25 has changed in dimension due to thermal expansion, thermal contraction, or the like will be described.

In an initial state, the composite light guiding member 20 is held and accommodated between the long side plates 12A with the elastic curved section 23C being slightly elastically deformed from a natural state inside the side frame 12 of the chassis 10 and the LED 21 mounted on the LED substrate 23 being lightly urged toward the light entering surface 25A of the light guide plate 25. In FIG. 2, the composite light guiding member 20 in an initial state held inside the chassis 10 is indicated by a solid line.

When the light guide plate 25 thermally expands because a temperature in the chassis 10 rises due to heat generation from the LED 21, for example, the light entering surface 25A is pressed and displaced in a direction toward the left (toward the LED 21 and the LED substrate 23) in FIG. 2 in the Y-axis direction (first direction). In FIG. 2, the composite light guiding member 20 with the light guide plate 25 thermally expanding is indicated by a two-dot and dash line. As the light entering surface 25A is displaced, the LED substrate 23 in which both the side edges 23B1 and 23B2 are fixed to the vicinity of the light entering surface 25A is also pressed in the same direction, and the elastic curved section 23C is elastically deformed, as indicated by a two-dot and dash line, by contacting the long side plate 12A disposed on the left side in FIG. 2. Thus, the dimensional change due to the thermal expansion of the light guide plate 25 is absorbed by the deformation of the elastic curved section 23C. As a result, a relative positional relationship between the light emission surface 21A of the LED 21 and the light entering surface 25A of the light guide plate 25 is maintained, and the distance d at which both the surfaces do not physically interfere with each other is maintained. Then, if the light guide plate 25 contracts because the temperature inside the chassis 10 decreases, the deformation of the elastic curved section 23C is restored as the light entering surface 25A is displaced toward the right in FIG. 2, and the relative positional relationship between the light emission surface 21A and the light entering surface 25A is maintained. That is, in the backlight device 3 including the composite light guiding member 20, both the side edges 23B1 and 23B2 in the LED substrate 23 on which the LED 21 is mounted are fixed to the vicinity of the light entering surface 25A. In addition, the elastic curved section 23C is elastically deformed so that the dimensional change due to the thermal expansion or the thermal contraction of the light guide plate 25 is reversibly absorbed. Accordingly, the relative positional relationship between the light emission surface 21A and the light entering surface 25A is always maintained to be substantially constant.

As described above, the composite light guiding member 20 according to the first embodiment includes the LED (an example of the light source) 21, the light guide plate 25 which forms a plate shape and receives light of the LED 21 emitted from the one outer peripheral end surface as the light entering surface 25A and emits the light as planar light, and the LED substrate (an example of the light source substrate) 23 which forms an elastically deformable sheet shape, has the switching circuit configured to control turn-on and turn-off of the LED 21 formed therein, and has the mounting surface 23A on which the LED 21 is mounted along the first side edge (one side edge) 23B1, in which the LED substrate 23 is folded such that the first side edge 23B1 is fixed to the surface on the opposite side to the light emission surface 25B (one of the plate surfaces) of the light guide plate 25 and the elastic curved section 23C which is relatively displaceable with respect to the light entering surface 25A while the LED 21 opposes the light entering surface 25A, so that the second side edge (the other side edge) 23B2 with the mounting portion of the LED 21 sandwiched between the first side edge 23B1 and itself is fixed to the light emission surface 25B (the other plate surface) of the light guide plate 25.

In the above-described configuration according to the first embodiment, both the side edges 23B1 and 23B2 in the LED substrate 23 are fixed to the light guide plate 25 so that a relative positional relationship between the light entering surface 25A of the light guide plate 25 and the LED 21 is maintained to be substantially constant. Accordingly, an influence of a dimensional change of the light guide plate 25 on a brightness level is suppressed. The LED 21 is preferably disposed to be close to the light entering surface 25A from the viewpoint of maintaining the relative positional relationship between the light entering surface 25A of the light guide plate 25 and the LED 21 to be constant.

Usually, a large number of wirings constituting the switching circuit are disposed on the LED substrate 23. Accordingly, a fixed area is required. According to the above-described configuration, the LED substrate 23 is folded to forma U shape in cross section, for example, and the wiring region in the LED substrate 23 forms the elastic curved section 23C so that the dimensional change of the light guide plate 25 can be absolved within the backlight device 3 including the LED substrate 23.

An effect of maintaining the relative positional relationship and an effect of absorbing the dimensional change of the light guide plate 25 by the elastic curved section 23C, as described above, can be obtained without providing a special structure in the chassis (one example of the holder) 10 in the backlight device 3 nor performing special assembling work but by only disposing the composite light guiding member 20 having the above-described configuration previously manufactured inside the chassis 10 having a similar configuration to that in the conventional example, for example. The light entering surface 25A of the light guide plate 25 is covered with the LED substrate 23. Accordingly, a situation where a foreign substance drops to be mixed between the LED 21, the LED substrate 23, the reflective sheet 17 disposed thereunder, and the like and the light guide plate 25, causing a display defect and damaging each of members, is reduced.

In the composite light guiding member 20 according to the above-described first embodiment, the mounting surface 23A of the LED substrate 23 is formed to reflect light.

According to the above-described configuration, the light entering surface 25A of the light guide plate 25 is covered with the mounting surface 23A of the LED substrate 23 which reflects light. Accordingly, the use efficiency of light emitted from the LED 21 can be increased.

In the composite light guiding member 20 according to the above-described first embodiment, the one or more LEDs 21 are mounted to form each of the first light source array (one light source array) 21L1 along the first side edge 23B1 and the second light source array (other light source array) 21L2 along the second side edge 23B2 in the LED substrate 23.

According to the above-described configuration, the light source arrays are respectively disposed in two columns so that a larger number of LEDs 21 can be disposed to oppose the light entering surface 25A than when the light source array is disposed in one column. As a result, such brightness level unevenness (so-called eyeball unevenness) that a local bright portion is visually recognized in the vicinity of each of the LEDs 21 for the light guide plate 25 is suppressed. In the LED substrate 23, the LEDs 21 are disposed on both sides with the elastic curved section 23C sandwiched therebetween, and both the side edges 23B1 and 23B are fixed to the light guide plate 25 to be substantially symmetrical about a center line in a thickness direction of the composite light guiding member 20. Accordingly, stress acting on the LED substrate 23 at the time of elastic deformation is dispersed in a balanced manner, and damage to the base material or the wiring in the LED substrate 23 is suppressed.

The backlight device (an example of the lighting device) 3 according to the first embodiment includes the composite light guiding member 20 according to the above-described first embodiment and the chassis (an example of the holder) 10 which supports the composite light guiding member 20 inside thereof.

According to the above-described configuration, the backlight device 3 having a simple configuration the brightness level of which can be stabilized can be obtained.

In the backlight device 3 according to the above-described first embodiment, the chassis 10 includes the side frame (an example of the frame portion) 12 disposed to surround the outer periphery of the composite light guiding member 20, and the side frame 12 is formed such that a distance between the paired long side plates (an example of the first direction supporting sections) 12A which support the composite light guiding member 20 from both sides in the Y-axis direction (corresponding to the first direction) including the elastic curved section 23C becomes equal to the outer dimension in the Y-axis direction (the first direction) of the composite light guiding member 20 in a natural state.

According to the above-described configuration, the elastic curved section 23C capable of absorbing the dimensional change of the light guide plate 25 is formed in the composite light guiding member 20. Accordingly, a clearance for dimension absorption conventionally provided inside the chassis 10 is not required so that the frame of the backlight device 3 the brightness level of which has been stabilized can be narrowed.

Note that “equal” in the above-described configuration includes not only “completely equal” but also “substantially equal”. The distance between the long side plates 12A may be larger or smaller than the outer dimension in the Y-axis direction of the composite light guiding member 20 if it is within a range in which the effect of the present invention is obtained. If the distance between the long side plates 12A is made large, a difference of the distance from the outer dimension of the composite light guiding member 20 is preferably set smaller than the clearance for dimension absorption conventionally provided. Although the distance between the long side plates 12A is made small in the first embodiment, the difference from a dimensional difference in this case is preferably set to be able to absorb the dimensional change due to the thermal expansion of the light guide plate 25 by the elastic deformation of the elastic curved section 23C. The distance between the long side plates 12A in the first embodiment is made slightly smaller than the outer dimension in the Y-axis direction of the composite light guiding member 20, and is preferable from the viewpoint of maintaining a state where the LED 21 is urged toward the light entering surface 25A.

The liquid crystal display device (an example of the display device) 1 according to the first embodiment includes the backlight device 3 according to the above-described first embodiment, and the liquid crystal panel 2 which performs display using light from the backlight device 3.

According to the above-described configuration, the liquid crystal display device 1 having a simple configuration the brightness level of which can be stabilized and the frame of which can be narrowed can be obtained.

### First Modification to First Embodiment

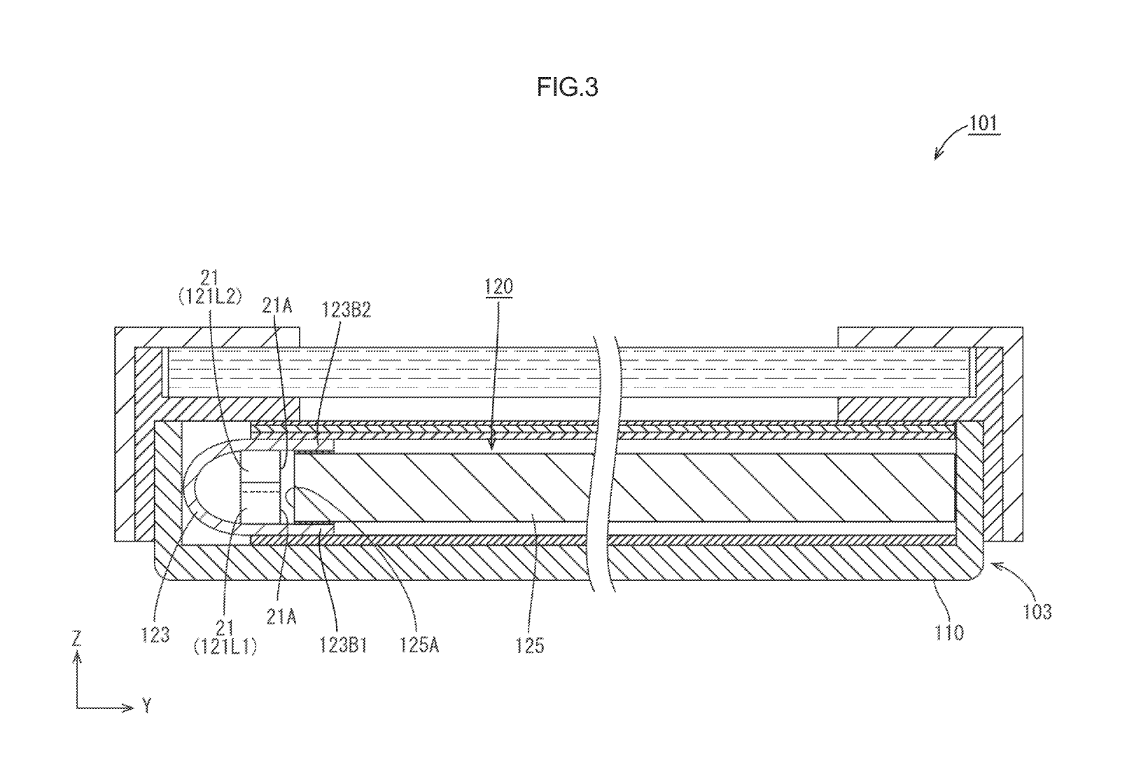

A first modification to the first embodiment will be described with reference to FIG. 3. In a composite light guiding member 120 according to the first modification, an arrangement of LEDs 21 mounted on an LED substrate 123 differ from those in the composite light guiding member 20 according to the first embodiment. Similar components to those in the first embodiment are assigned the same reference numerals, and description thereof is not repeated (the same is true for a second modification).

Although similar LEDs 21 to those in the first embodiment are used in the first modification, the LEDs 21 are mounted to form a zigzag shape at respective positions which have shifted from each other in an X-axis direction in a first light source array (one of light source arrays) 121L1 formed along a first side edge 123B1 as one of side edges on the long side of the LED substrate 123 and a second light source array (the other light source array) 121L2 formed along a second side edge 12332 as the other side edge.

When the LED substrate 123 is fixed to a light guide plate to form a composite light guiding member 120, a light guide plate 125 having a smaller plate thickness than that of the light guide plate 25 in the first embodiment is used, and a thinner chassis 110 than the chassis 10 in the first embodiment is used.

In a configuration according to the above-described first modification, the LEDs 21 and the LEDs 21 respectively constituting the light source arrays 121L1 and 121L2 in two columns are alternately disposed so that brightness level unevenness (eyeball unevenness) is further reduced. When the LEDs 21 are each disposed such that its light emission surface 21A opposes a light entering surface 125A of the light guide plate 125, the LEDs 21 and the LEDs 21 respectively constituting the light source arrays 121L1 and 121L2 can be superimposed in a Z-axis direction so that a restriction in a thickness dimension of the light guide plate 125 is relaxed. Accordingly, a thinner light guide plate 125 can be used. As a result, the thickness dimension of the composite light guiding member 120 can be reduced. Therefore, a backlight device 103 and thus a liquid crystal display device 101 can be made thinner than in the first embodiment.

### Second Modification to First Embodiment

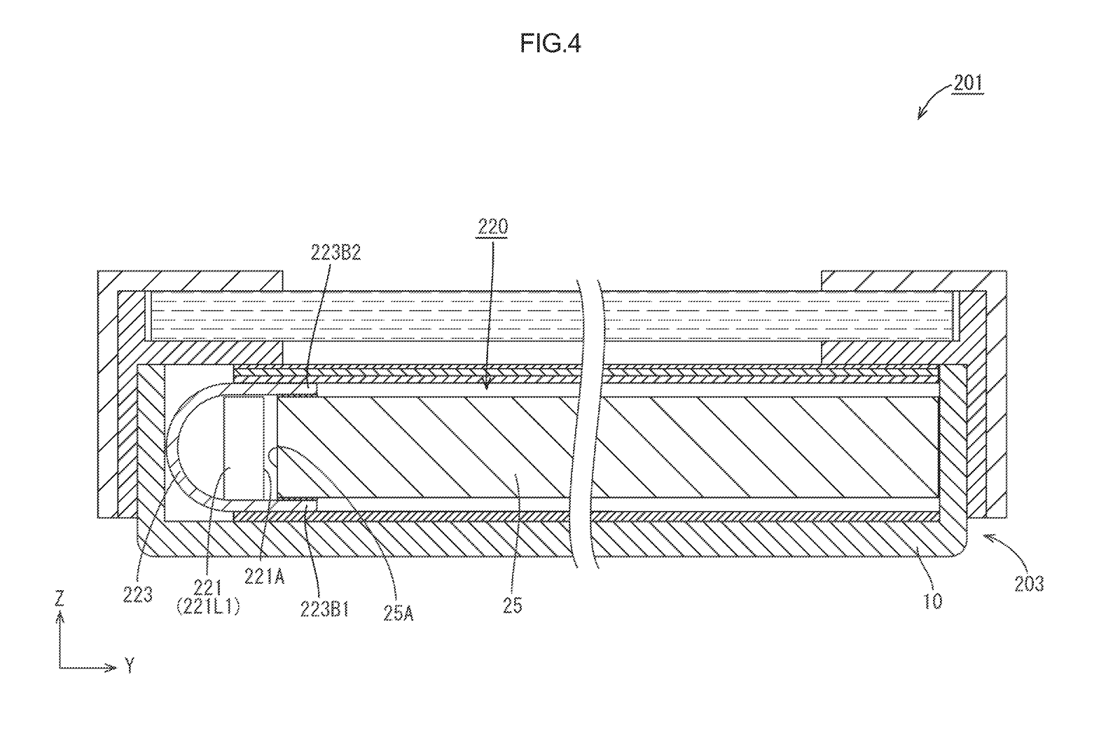

A second modification to the first embodiment will be described with reference to FIG. 4. In a liquid crystal display device 201 according to the second modification, a dimensional shape and an arrangement of an LED 221 mounted on an LED substrate 223 differ from those of the LED 21 according to the first embodiment 1.

In a composite light guiding member 220 according to the second modification, an LED 221 thicker than the LED 21 according to the first embodiment and having an equal thickness dimension to the thickness dimension of the light guide plate 25 is used. In the second modification, a first light source array (one light source array) 121L1 is only formed along a first side edge 223B1 as one of side edges on the long side of the LED substrate 223, and the LED 221 is not mounted on the side of a second side edge 223B2 as the other side edge.

Even if the number of light source arrays formed by the LED 221 is one, like in the second modification, the side edge of the LED substrate 223 on which the LED 221 is mounted is fixed to the light guide plate 25. Accordingly, an effect of maintaining a relative positional relationship and an effect of absorbing a dimensional change of the light guide plate 25 described for the first embodiment can be obtained. In the second modification, the LED 221 having a larger dimensional shape and having a higher brightness level can be used. When a center line in a Z-axis direction of a light emission surface 221A of the LED 221 and a center line in the same direction of a light entering surface 25A of the light guide plate 25 are made to substantially oppose each other, the use efficiency of light emitted from the LED 221 can be increased. As a result, a high brightness level can be stably obtained for a backlight device 203.

### Other Embodiments

The technology described herein is not limited to the embodiments described above with reference to the drawings. The following embodiments may be included in the technical scope.

(1) The technology is also applicable to a configuration in which a light source substrate covers apart of a light entering surface or a configuration in which an flexible curved section is intermittently provided.

(2) Alternatively, light sources may be oppositely arranged, respectively, on outer peripheral end surfaces on both the long sides or outer peripheral end surfaces on both the short sides of the light guide plate. In such a case, a flexible curved section can be provided to cover one or more outer peripheral end surfaces (light entering surfaces), on which the light sources are respectively oppositely arranged, of the light guide plate.

(3) The technology is also applicable to a light guide plate having a polygonal shape such as a triangular shape or a pentagonal shape or a shape formed of a contour line including a curve such as a circular shape or a trapezoidal shape in a planar view. The light guide plate may be curved, for example.

(4) If the plurality of light guide plates are arranged to be stacked, both side edges of the light source substrate can be respectively fixed to plate surfaces of light guide plates positioned on an uppermost layer and a lowermost layer after respective vicinities of light entering surfaces of the light guide plates are fixed to one another, for example. Alternatively, one or more composite light guiding members respectively including light guide plates may be formed and arranged to be stacked in the lighting device.

(5) Further, the reflective layer may also be formed on an outer peripheral end surface excluding a light entering surface of the light guide plate.

(6) A cold cathode fluorescent lamp or an organic EL, for example, can also be used as a light source of another type.

(7) The technology is also applicable to a display device using a display panel of another type.

1. A composite light guiding member comprising:
light sources;
a light guide plate having a plate shape, the light guide plate including a first plate surface, a second plate surface, and an end surface, the end surface including a light entering surface through which light emitted by the light sources enters, at least one of the first plate surface and the second plate surface including a light exiting surface through which planar light exits; and
a light source substrate having a sheet shape and being flexible, the light source substrate including: a switching circuit configured to control turn-on and turn-off of the light sources; a first side edge fixed to the first plate surface; a second side edge fixed to the second plate surface; amounting surface on which the light sources are disposed along the first edge, the mounting surface being between the first side edge and the second side edge; and a flexible curved section including the mounting surface and being folded so that the light sources are opposed to the light entering surface and displaceable relative to the light entering surface.

2. The composite light guiding member according to claim 1, wherein the mounting surface of the light source substrate is configured to reflect light.

3. The composite light guiding member according to claim 1, wherein the light sources include the light sources arranged in a first source array along the first side edge and the light sources arranged in a second light source array along the second side edge.

4. The composite light guiding member according to claim 3, wherein the light sources in the first light source array and the second light source array are arranged in zigzag.

5. A lighting device comprising:
the composite light guiding member according to claim 1; and
a holder holding the composite light guiding member.

6. The lighting device according to claim 5, wherein
the holder includes a frame portion disposed to surround a periphery of the composite light guiding member,
the frame portion includes holding sections separated from each other in a first direction in which the light entering surface and an opposite surface on an opposite side from the light entering surface are separated, and
the holding sections are held against the flexible curved section and the opposite surface to hold the composite light guiding member in the first direction so that a distance between the holding sections is about equal to an outer dimension of the composite light guiding member in a natural state in the first direction.

7. A display device comprising:
the lighting device according to claim 5; and
a display panel configured to display an image using light from the lighting device.
